(19) United States
(12) Patent Application Publication
(10) Pub. No.: US 2026/0308336 A1
(43) Pub. Date: Oct. 8, 2026

(54) PROCESS FOR THE PRODUCTION OF RECYCLED LIGNOCELLULOSE FRAGMENTS

(71) Applicant: UNILIN, BV, Wielsbeke (BE)

(72) Inventor: Geert COUDENYS, Wielsbeke (BE)

(21) Appl. No.: 19/482,366

(22) PCT Filed: Apr. 29, 2024
(86) PCT No.: PCT/IB2024/054140

§ 371 Date: Nov. 7, 2025

Related U.S. Application Data
(60) Provisional application No. 63/502,123, filed on May 15, 2023.

(51) Int. Cl. C08H 8/00

(52) U.S. Cl. CPC C08H 8/00

(57) ABSTRACT

A process for the production of recycled lignocellulose fragments, includes a step in which refined material from recycled lignocellulose based boards or panels is introduced into a receptacle, and wetted, heated and pressurized using steam; wherein the process includes a step of steam explosion of the wetted, heated and pressurized material, in which the pressure in the receptacle is reduced by at least 3 bar, and in which recycled lignocellulose fragments are produced; wherein the steam explosion is a multistage steam explosion.

The invention relates to a process for the production of recycled lignocellulose fragments, for example recycled wood fibers or recycled wood chips. This invention also relates to a process for the production of lignocellulose based boards, for example wood fiberboard—such as MDF (Medium Density Fiberboard) or HDF (High Density Fiberboard) or of softboard or of hardboard—, in which recycled lignocellulose fragments obtained from recycling lignocellulose based boards—for example from recycling MDF (Medium Density Fiberboard) and/or from recycling HDF (High Density Fiberboard) boards and/or from recycling softboard and/or from recycling hardboard—are used, at least to some extent, as feedstock.

WO2011/077155A1 describes a method for recycling “engineered wood panels”, such as wood fiberboards, wherein wood fibers are recovered which can be used as a substitute for new wood fibers.

US2003/0056873A1 describes a process for producing wood fiberboards—via recycling of waste from composite wood products—by means of a conventional dry production process for producing wood fiberboards. The process employs a modified treatment in a pre-heater, followed by mechanical refining in a “refiner”, resulting in recycled fibers. In the pre-heater, the recycled wood products are chemically treated under pressure in the presence of steam. It is a drawback of this process that chemicals have to be added in the pre-heater.

WO2005/007968A1 relates to a method for recovering wood constituents from a board material consisting of a matrix of lignocellulose material bonded by glue. The method comprises treating the material with a combination of electromagnetic radiation and soaking or immersing it in a liquid medium, and recovering constituents. It is a drawback that special equipment is required to generate the electromagnetic radiation to heat the material, and that it is more difficult to incorporate such a process in a continuous process.

WO01/39946A1 describes a process for producing fiberboards via recycling of waste of composite wood products by means of a conventional continuous dry wood fiberboard process, wherein the process in the pre-heater and/or in the refiner is modified. These modifications ensure that fiberboards comprising at least 20 percent by weight of recycled fibers can be produced.

It is a problem of the recycling methods from the prior art for recycling MDF and HDF boards that they require complicated equipment, that they are difficult to incorporate in existing production processes for chipboard, MDF or HDF boards, they are not economically cost-effective and they do not result in the required and continuous good quality of boards produced using the recovered material.

WO 2023/031763 A1 describes among others a process for the production of wood fiber boards, wherein recycled wood fibers are being produced and wherein these recycled wood fibers are used for the formation of new wood fiber boards.

It is an object of the invention to offer a solution to shortcomings in the recycling processes for lignocellulose based boards and panels into recycled lignocellulose fragments and to improve the production of new lignocellulose based boards comprising recycled lignocellulose fragments.

The invention, according to a first aspect, relates to a process for the production of recycled lignocellulose fragments, such as recycled wood fibers or recycled wood chips, wherein the process comprises a first step in which refined material from recycled lignocellulose based boards or panels—preferably from recycled MDF or HDF—is introduced into a receptacle, and wetted, heated and pressurized using steam; wherein the process optionally comprises a second step in which this material is kept under pressure and temperature for a certain amount of time in said receptacle,
wherein the process comprises a third step of steam explosion of the wetted, heated and pressurized material, in which the pressure in the receptacle is reduced by at least 3 bar, and preferably by at least 5 bar, more preferably by at least 7 bar; more preferably by at least 10 bar, more preferably by at least 11 bar; and in which recycled lignocellulose fragments, such as recycled wood fibers or recycled wood chips, are produced during said steam explosion;
wherein the steam explosion is a multistage steam explosion, meaning that the reduction of the pressure takes place in at least two partial steps, wherein the multistage steam explosion comprises at least a first partial step wherein the pressure in the receptacle is reduced, and a subsequent second partial step wherein the pressure in the receptacle is further reduced, wherein a first ratio of the pressure drop in the first partial step to the duration of the reduction of the pressure in the first partial step, is lower than a second ratio of the pressure drop in the second partial step to the duration of reduction of pressure in the second partial step.

Preferably said at least two partial steps are clearly distinguishable from one another. This can be through one or more of the following options:
a valve or flap which can take up different positions (for example fully open or partially open), wherein for example in the second partial step the flap or valve is more open than in the first partial step.
a pump (e.g. a vacuum pump) with an adjustable flow rate. For example in the first partial step the pump is not used, and in the second partial step the pump creates a flow from the receptacle or, in the first partial step the flow rate is lower than in the second partial step;
at least two valves or flaps, wherein for example a first said valve or flap is opened for the first partial step and a second said valve or flap is opened for the second partial step.
   Of course, other options are possible.

Both in the first partial step and the second partial step, there is a reduction in pressure in the receptacle, thus a pressure drop. In the first partial step, this pressure drop is slower than in the second partial step, such that the steam explosion starts gradually, but is still very effective. The advantage in this is that the recycled lignocellulose fragments are produced more gradually, but still in a good and efficient manner, and the production of said recycled lignocellulose fragments can be controlled more effectively. The result is also more uniform recycled lignocellulose fragments, which are more suitable to be used in the production of new lignocellulose based boards. The risk that recycled lignocellulose fragments get lost and/or block or pollute parts of the installation in which the process takes place, is also smaller. To release pressure from the receptacle, an opening needs to be present, through which the pressure can be released. By providing said at least two partial steps, the risk of blocking said opening and/or loss of recycled lignocellulose fragments trough said opening is much reduced in comparison to a more abrupt pressure drop. This process makes it possible to make recycled lignocellulose fragments in an efficient manner.

Said recycled lignocellulose based fragment can then be used as raw material in a process for the production of a new lignocellulose based board. For example if the recycled lignocellulose fragments are recycled wood fibers, they can be used for the production of a wood fiberboard, preferably for the production of an MDF or HDF board.

With the steam explosion, there can be produced, next to the recycled lignocellulose fragments, a fraction of clumps and any other impurities. Preferably, the quantity of clumps after the steam explosion is less than 5 percent by weight, preferably less than 3 percent by weight, more preferably less than 2 percent by weight, even more preferably less than 1 percent by weight. Such embodiments afford even greater efficiency to the process. These embodiments may be carried out by a suitable choice of the process parameters, preferably due to the fact that in the first step, the material is brought to above 10 bar, preferably 11 bar, more preferably 12 bar. If this is optionally affected using saturated steam, even greater energy efficiency of the process is obtained. The energy efficiency is expressed as the quantity of energy required per mass quantity of produced recycled lignocellulose fragments.

During the second step, in which this material is kept under pressure and temperature for a certain amount of time in said receptacle, a minor pressure drop is possible. For example the receptacle cannot be completely pressure-tight, such that pressure drop is possible. With a minor pressure drop is indicated a pressure drop of less than 4 bar, preferably less than 3 bar, more preferably at most 2 bar.

The recycled lignocellulose based boards or panels are chosen from end-of-life boards or panels. With end-of-life panels or boards can be indicated panels or boards of the non-exhaustive list: panels or boards that have been used by an end consumer and/or waste from production and/or waste from installation and/or waste from shipping and/or waste from marketing and/or unsold stock. The recycled lignocellulose based boards or panels are chosen from the non-exhaustive list:
wood fiber boards, such as HDF (high density fiberboard), MDF (medium density fiberboard), LDF (low density fiberboard), softboard or hardboard;
particle board, OSB (oriented strand board), plywood, glulam;
flax board, hemp board, bamboo boards;
wood plastic composite board;
laminate comprising a lignocellulose based substrate, such as wood fiberboard or particle board, and for example one or more resin impregnated paper layers and/or a veneer layer;
solid wood panels, engineered wood panels;
etc.

The refined material can have an average size according to numbers of less than 10 cubic centimetres, more preferably less than 5 cubic centimetres, more preferably less than 3 cubic centimetres.

The first ratio and the second ratio are average ratio's, meaning that the pressure drop is the total pressure drop during said partial step and the duration is the total duration of pressure drop in said partial step. Preferably during the entire time of said partial step, there is reduction in pressure such that the duration of pressure drop in said partial step, is the total time of the duration of said partial step. The instantaneous ratio of pressure drop to duration can or cannot be constant during a said partial step. The instantaneous ratio being the ratio measured over time intervals which are smaller than the total duration of pressure drop in a said partial step, being for example measured per second, or per half of a second, or per quarter of a second. Preferably the maximum instantaneous ratio of the first partial step is lower than the maximum instantaneous ratio of the second partial step. Preferably the maximum instantaneous ratio of the pressure drop to the duration of the reduction of the pressure in the first partial step, is at most 1 bar/second. Pressure is normally released by opening of valve or flap. When opening this valve or flap to start the first partial step, a high pressure is present, such that a high said maximum instantaneous ratio can be present, however it is preferred that when opening this valve or flap, one ensures that the instantaneous ratio of the pressure drop to the duration of the reduction of the pressure at the time of opening said valve or flap, is lower than 1 bar/second.

Preferably the first ratio is at most 0,4 bar/second, preferably at most 0,2 bar/second, more preferably at most 0,1 bar/second. The first ratio can be 0,35 bar/second or 0,24 bar/second or 0,13 bar/second. For example
the pressure drop can be at most 7 bar in the first partial step and the duration of pressure drop can be at least 20 seconds, such that the first ratio is at most 0,35 bar/second;
the pressure drop can be at most 6 bar in the first partial step and the duration of pressure drop can be at least 25 seconds, such that the first ratio is at most 0,24 bar/second;
the pressure drop can be at most 4 bar in the first partial step and the duration of pressure drop can be at least 30 seconds, such that the first ratio is at most 0,13 bar/second.

In the first partial step, the pressure reduction is preferably at most 8 bar, more preferably at most 7 bar. In the second partial step, there can be a sufficient amount of pressure left, that will be reduced in a faster manner, such that the steam explosion can take place in a sufficient way and recycled lignocellulose fragments of the desired quality are obtained.

In first partial step the duration of reduction of pressure is preferably at least 10 seconds, more preferably at least 20 seconds, for example 30 seconds. Here there is enough time to start the steam explosion gradually.

In a preferred embodiment, the second ratio is at least 0,25 bar/second, preferably at least 0,50 bar/second, most preferably at least 0,75 bar/second. This ensures that the pressure reduction is fast enough to have a good separation of the refined material into recycled lignocellulose fragments, with the lignocellulose fragments having a good quality. The first ratio can be 0,33 bar/second, 0,6 bar/second or 0,87 bar per second. For example
the pressure drop can be at least 5 bar in the second partial step and the duration of pressure drop can be at most 15 seconds, such that the second ratio is at least 0,33 bar/second;
the pressure drop can be at least 6 bar in the second partial step and the duration of pressure drop can be at most 10 seconds, such that the second ratio is at least 0,6 bar/second;
the pressure drop can be at least 7 bar in the second partial step and the duration of pressure drop can be at most 8 seconds, such that the second ratio is at least 0,875 bar/second.

Preferably the pressure drop of the first partial step is at least 30 percent of the total pressure drop in the third step, preferably at least 40 percent, most preferably approximately 50 percent. This ensures a good balance between a slow and fast pressure release, such that good quality lignocellulose fragments are obtained in an efficient manner. For example the pressure drop in the first partial step and the second partial step can be approximately the same and further preferably there is only a first partial step and a second partial step such that both the first and the second partial step are approximately 50 percent of the total pressure drop. When, in the first step, the material is brought to above 10 bar, preferably 11 bar, more preferably 12 bar, for example 14 bar then the pressure drop in the first and/or the second partial step can be respectively 4,5 bar, 5 bar or 5,5 bar or 6,5 bar.

In a very preferred embodiment the receptacle comprises a pressure vessel and a first flap or valve to release pressure from the pressure vessel, wherein preferably said first flap or valve renders a first pipe connected to the pressure vessel closable, wherein in the first step said first flap or valve is at least partially opened to release pressure. This flap or valve can be opened gradually during the first step, such that the instantaneous ratio of pressure drop to the duration of pressure drop is approximately constant during the first partial step and/or not higher than a certain maximum, for example at most 1 bar/second. Said instantaneous ratio does not have to be constant. By gradually opening said valve or flap, the risk that that recycled lignocellulose fragments will block the valve or flap or the first pipe, is reduced. Preferably said first pipe is present and pressure is released trough said first pipe. With the aid this valve or flap and with the aid of said optional first pipe, also water that could be the result of condensation during this process, can be easily discharged, such that lignocellulose fragments with the desired moisture content can be obtained.

The refined material from recycled lignocellulose based boards or panels, preferably has a moisture content of at most 15 percent by weight, even more preferably a moisture content of at most 10 percent by weight.

The recycled lignocellulose fragments preferably have a moisture content of at most 15 percent by weight, even more preferably a moisture content of at most 10 percent by weight, for example 8 percent by weight, directly after said steam explosion.

Further preferably liquid water can be discharged trough said first flap or valve, and preferably the first flap or valve is connected to a bottom part of the pressure vessel. This liquid water is then preferably discharged during the third step and preferably at least during the first partial step. This has the additional advantage that the recycled lignocellulose fragments have a relatively low moisture content, for example a moisture content of at most 20 percent by weight, that is to say for example a moisture content of between 10 and 15 percent by weight. These recycled lignocellulose fragments, if they are recycled wood fibers, can then be used directly in the production of wood fiberboards, without requiring an additional drying process. This embodiment additionally has the advantage that the discharging of the liquid water, mainly formed by condensation, increases the efficiency of the process.

Also further preferably, the receptacle comprises a second flap or valve, which preferably renders a second pipe connected to the pressure vessel closable, wherein in the second step said second flap or valve is at least partially opened to release pressure. With the aid of a second flap or valve, one can very easily have said first and second partial steps. Different embodiments are possible. Here below a non-exhaustive list of possibilities are given:
first possibility: the first valve or flap is opened to start the first partial step. Subsequently the first valve or flap is closed, to end the first partial step. When the first flap or valve is closed, the second valve or flap is opened to start the second partial step, and then the second flap or valve is closed to end the second partial step.
second possibility: the first valve or flap is opened to start the first partial step. Subsequently the first valve or flap is closed, to end the first partial step. During closing of the first flap or valve, the second valve or flap is opened to start the second partial step, and the second flap or valve is closed to end the second partial step.
third possibility: the first valve or flap is opened to start the first partial step. Subsequently the second valve or flap is opened, to start the second partial step and end the first partial step. Then the first valve or flap is closed and later or at the same time the second valve or flap is closed to end the second partial step. Closing the first flap or valve can be done before or during the closing of the second flap or valve. Preferably the first flap or valve is closed before the second valve or flap is closed. In this manner one can easily reduce the pressure in the pressure valve by subjecting the second pipe to suction and/or vacuum, this for example by connecting the second pipe to an expansion vessel.

Of course, if only a first valve or flap is available, one can have also said first and second partial step and this for example by controlling the amount of opening of said valve or flap.

More preferably the first valve is connected to said first pipe and the second valve is connected to said second pipe, wherein the diameter of the first pipe is smaller than the diameter of the second pipe. With the aid of a smaller first pipe, the pressure reduction in the first partial step can be sufficiently low and with the aid of a bigger second pipe, it can be ensured that the pressure reduction in the second partial step is sufficiently high. If use is made of the third possibility and/or an expansion vessel is at least connected to said second pipe and/or by controlling the amount of opening of said flaps or valves, different diameters of the first pipe and the second pipe can be optional, and this still with a first ratio lower than the second ratio.

Also further preferably, the pressure vessel is positioned in such a way that it has a bottom side and a top side, wherein the first flap or valve is located closer to the bottom side and the second flap valve is located closer to the upper side. This way the first flap or valve is ideally positioned to also release liquid water and/or to release pressure in a slower manner, this since the refined material will be located above and/or at the height of said first flap or valve. The second flap or valve is also ideally positioned to release pressure in a faster manner, since it will be located above the refined material and/or at the height of higher located refined material.

Also further preferably, the receptacle comprises a grid which is positioned inside the pressure vessel and divides the pressure vessel in at least two distinct areas which extend above each other, a higher area above the grid wherein the refined material from recycled wood based boards or panels is introduced and a lower area below the grid, wherein the first valve or flap connects to the pressure vessel at the height of the lower area and wherein preferably the said second valve or flap (if present) connects to the pressure vessel at the height of the higher area. Said grid hinders the refined material to enter the second area and therefore prevents the first flap or valve of getting blocked during the third step. Said grid forms a separating surface between said higher and lower area, and said surface can have a grid structure, thus openings, over approximately its entire surface and/or it can have closed sections where no openings are present. The grid structure can have a constant pattern, or different patterns are possible, with for example differently shaped openings and/or different distances between openings. Preferably the pressure vessel is designed in such a way that the grid can be easily cleaned, for example a steam inlet can be present at the height of the grid, such that when pressurizing the pressure vessel, the grid is also cleaned.

Als further, in a specific embodiment, a filter is present between the pressure vessel and said flap or valve. This filter can be designed as a grid or grille, such that the air flow trough said filter can be sufficiently high. This filter will prevent recycled lignocellulose fragments to go past said valve or flap. The pressure vessel is preferably designed in such a way that the filter can be easily cleaned and/or can be removed to clean or replace.

In a specific embodiment, said valve or flap is connected to an expansion vessel. With the aid of an expansion vessel the pressure drop can be sufficiently fast and/or can be controlled in a good manner. For example a sufficiently fast pressure drop to approximately atmospheric pressure or below atmospheric pressure can be very easily controlled with the aid of an expansion vessel. This expansion vessel can be connected to a pump, such as a vacuum pump to actively reduce the pressure. With an expansion vessel, pressure can be actively diminished. A further advantage when using an expansion vessel is that if recycled lignocellulose fragments end up in the expansion vessel, these can be easily recovered.

The invention, according to a second aspect, relates to a process, optionally according to the first aspect of the invention, for the production of recycled lignocellulose fragments, such as recycled wood fibers or recycled wood chips, wherein the process comprises a group of sequential steps, and the process makes use of at least a first receptacle and a second receptacle, wherein said group of sequential step take place in the first receptacle and wherein said group of sequential steps also takes place in the second receptable, wherein said group of sequential steps at least comprise
a first step in which refined material from recycled lignocellulose based boards or panels—preferably from recycled MDF or HDF—is introduced into the first receptacle or respectively the second receptacle, and is wetted, heated and pressurized using steam;
an optional second step in which this material is kept under pressure and temperature for a certain amount of time in the first receptacle or respectively the second receptacle,
a third step of steam explosion of the wetted, heated and pressurized material, in which the pressure in the first receptacle or respectively the second receptacle is reduced by at least 3 bar, and preferably by at least 5 bar, more preferably by at least 7 bar; more preferably by at least 10 bar, more preferably by at least 11 bar; and in which recycled lignocellulose fragments are produced during said steam explosion;
   wherein
to reduce the pressure in the first receptacle or respectively the second receptacle in the third step, steam is released from the first receptacle or respectively the second receptacle and at least partially reused for pressurizing the second receptacle or respectively the first receptacle, and this at the time the first step takes place in the second receptacle or respectively the first receptacle, such that the steam is partially reused.

The first step and the second step of the first aspect are preferably the same as the first step and the second step of the second aspect. The third step of the first aspect can be the same as the third step of the second aspect. However the third step of the second aspect can or cannot be a multistage steam explosion. If the third step of the second aspect is a multistage steam explosion, preferably the features and embodiments of the first aspect of the invention, also apply to this second aspect of the invention. In the process according to the first aspect, steam can or cannot be at least partially reused for pressurizing another receptacle in which steam explosion will take place.

The advantage of the second aspect is that steam is partially reused, such that less energy is needed to produce a certain amount of recycled lignocellulose fragments and the consumption of steam is reduced. The result is a more sustainable process.

Preferably the steam explosion is a multistage steam explosion, meaning that the reduction of the pressure takes place in at least two partial steps; wherein the multistage steam explosion comprises at least a first partial step wherein the pressure in the receptacle is reduced and a subsequent second partial step wherein the pressure in the receptacle is further reduced, wherein the partially reusing of the steam takes places in the first partial step. Further preferably a first ratio of the pressure drop in the first partial step to the duration of the reduction of the pressure in the first partial step, is lower than a second ratio of the pressure drop in the second partial step to the duration of reduction of pressure in the second partial step. As a result, the reduction of pressure during the first partial step will be slower and steam can be reused quite easily. For example the first and the second receptacle can each have a pressure vessel, wherein said pressure vessels are connected to each other by one or more pipes, which can be closed with the aid of one or more valves or flaps. The first partial step of the third step in the first receptacle or respectively the second receptacle can then take place, by opening said one or more valves. By opening said one or more valves, said pressure vessels are in contact with each other and pressure will be reduced in the pressure vessel of the first receptacle or respectively the pressure vessel of the second receptacle and this while pressure in the pressure vessel of the second receptacle or respectively the pressure vessel of the first receptacle increases. Preferably, the pressure vessels have approximately the same dimensions and/or preferably the first partial step takes place until the pressure in the pressure vessel of the first receptacle is approximately the same as the pressure in the pressure vessel in the second receptacle.

Also further preferably, both the first receptacle and the second receptacle preferably have at least one additional valve or flap, which preferably connects to an expansion vessel. For the first partial step, then preferably only the valves or flaps that connect the pressure vessels to each other are at least partially opened. For the second partial step then a said additional valve or flap is opened. The closing of said valves or flaps, that connect said pressure vessels can be done before or simultaneously with, opening said additional valve or flap.

Further, in a preferred embodiment, in the first partial step, the pressure is released until the pressure in the first and the second receptacle differs at most 2 bar, preferably at most 1 bar and is more preferably approximately the same. This allows to reuse a relatively large amount of steam.

Preferably a valve or flap is arranged between the first and second receptacle as such to release the steam from one said receptacle and to reuse is in the other said receptacle.

Each receptacle is preferably further connected to an expansion vessel to further reduce the pressure to for example atmospheric pressure or below atmospheric pressure.

In a preferred embodiment, in the first or the second aspect, a said receptacle comprises a stirring mechanism, wherein this stirring mechanism mixes the refined material in the receptacle at least for a portion of the time period—and preferably for the entire time period—of the first and/or the second step. Further preferably said receptacle comprises a pressure vessel in which refined material from recycled lignocellulose based boards or panels is introduced, wherein the agitators are located inside said pressure vessel. This embodiment has the advantage that the refined material is treated homogeneously in the receptacle, as a result of which the process runs more rapidly and more efficiently, wherein the transformation into recycled lignocellulose fragments is affected more rapidly and more completely. Instead of operating with a stirring mechanism to obtain good mixing, it is also possible to opt to operate with a receptacle which is able to spin around, for example to rotate about an axis of rotation. Of course, it is possible to opt to operate with a receptacle which can spin around and which comprises a stirring mechanism.

Further preferably, the receptacle comprises a grid which is positioned inside the pressure vessel and divides the pressure vessel in at least two distinct areas which extend above each other, a higher area above the grid wherein the refined material from recycled wood based boards or panels is introduced and a lower area below the grid, wherein the one or more agitators are located in said higher area, and wherein further preferably the grid comprises a closable opening, wherein said one or more agitators are preferably also provided to stir after the steam explosion such as to guide the recycled lignocellulose fragments trough said opening and out of said pressure vessel.

For the first step, steam is introduced in the receptacle, for example in the pressure vessel if present. Said steam can be introduced in one or more places. For example the pressure vessel can be connected to one or more pipes to introduce steam into said pressure vessel. Some of said pipes can be located at a location were refined material and/or recycled lignocellulose fragments might accumulate. By introducing steam in a said location during the first step, possible accumulated refined material and/or recycled lignocellulose fragments is removed.

In a preferred embodiment in the first and/or the second aspect, in the first step, the material is brought to a pressure of at least 4 bar, preferably of at least 6 bar, more preferably of at least 7 bar, for example a pressure of between 7 and 9 bar, such as 8 bar, most preferably of at least 10 bar or at least 11 bar or at least 12 bar. It has been shown that both a high temperature and a high pressure are favourable for efficiently producing the recycled lignocellulose fragments. If the material is brought to a higher pressure, it is possible to implement a greater pressure drop during the third step. A large pressure drop has proven to have a positive effect on the efficiency of the process. In the case of a larger pressure drop, the material can be introduced more rapidly and/or the material does not have to be kept at pressure for as long and/or the used refined material from recycled lignocellulose based boards or panels can have a lower homogeneity/a lower quality. A lower homogeneity may for example indicate that there are a lot of large chunks present in the refined material from recycled lignocellulose based boards or panels. A lower quality may indicate that there are a lot of impurities present such as paper, metal, glass, plastic, etc. The material may be brought, for example, to a pressure of 12 bar, 13 bar or 14 bar. Preferably, the refined material from recycled lignocellulose based boards or panels is brought to a pressure of at most 20 bar, preferably at most 18 bar, such that no thermal damage occurs.

Preferably, for the first and/or the second aspect, after the third step, the recycled lignocellulose fragments have a moisture content of between 3 and 20 percent by weight, preferably of between 5 and 15 percent by weight, preferably of between 10 and 15 percent by weight. The moisture content may thus be between 10 and 13 percent by weight, for example 11 or 12 percent by weight.

Preferably, for the first and/or the second aspect, between 0.1 kg of steam and 1 kg of steam is consumed per kg of recycled lignocellulose fragments produced, even more preferably between 0.2 kg of steam and 0.7 kg of steam. For example 0.4 kg, 0.5 kg or 0.6 kg of steam is consumed for the production of 1 kg of recycled lignocellulose fragments.

Preferably, for the first and/or the second aspect, the period of time from starting the first step, to the beginning of the third step is less than 5 minutes, is preferably less than 3 minutes, is more preferably less than 2 minutes, is more preferably less than 90 seconds; and/or is preferably more than 40 seconds, more preferably at least 50 seconds. For example this time is 60 seconds. These embodiments have the advantage that a high degree of efficiency of the process is obtained.

The duration of the first step is at most 60 seconds, for example 50 seconds. This rapid heating step ensures that the formation of condensate is limited, and that optimal efficiency of the process is obtained, also and especially in terms of the energy required.

Preferably, for the first and/or the second aspect, the third step is carried out in a time span of less than 1 minute, preferably of less than 45 seconds, even more preferably of less than 30 seconds. This third step can be carried out in a time span of at least 15 seconds, for example of at least 20 seconds. The time span of the third step can be for example 40 seconds. If the third step comprises said first partial step and said second partial step, the time span of the second partial step is preferably smaller than the time span of the first partial step. For example the first partial step is at least 60% of the total time span of the third step, preferably at least 70%, for example approximately 75%. The second partial step is then at most 40% of the total time span of the third step, preferably at most 30%, for example approximately 25%.

Preferably, for the first and/or the second aspect, in the first step, the refined material is heated to a temperature lower than 240° C., preferably lower than 230° C.; and preferably higher than 130° C., and more preferably higher than 150° C., preferably higher than 170° C. Such temperatures are very suitable because they allow the lignocellulose fragments to be released efficiently without the lignocellulose fragments, such as the wood fibers, themselves being degraded, which would be the case at higher temperatures, since cellulose has a degradation temperature of 260° C.

Preferably the time span of the second step is at least 5 seconds, preferably at least 10 seconds.

It is possible to operate with two or more receptacles which are preferably arranged parallel to one another. If there are two or more receptacles, the latter may for example be operated alternately, in order to achieve continuity in the formation of recycled lignocellulose fragments.

After the third step, the process can comprise the step of separating off clumps and any other impurities, that are present in addition to the recycled lignocellulose fragments. This separating preferably makes use of the difference in mass between, on the one hand, the recycled lignocellulose fragments and, on the other hand, clumps and any other impurities.

Of course, this invention also relates to an installation that can be used for processes according to the invention. An installation for the production of recycled lignocellulose fragments, such as recycled wood fibers or recycled wood chips, on which the processes according to the invention, for example according to preferred or specific embodiments of the invention, can run. With regard to the installation, this typically refers to an installation comprising one or more receptacles as described above—e.g. receptacles comprising pressure vessels and valves or flaps—, and optionally expansion vessels, pipes, etc.

According to a third aspect, the invention relates to a process for the production of a lignocellulose based board, preferably for the production of an MDF or HDF board, wherein the process comprises the production of recycled lignocellulose fragments as disclosed in the first aspect and/or the second aspect of the invention, and wherein the process further comprises, the step of supplying the recycled lignocellulose fragments as feedstock in a production line—preferably in a dry production process—for producing lignocellulose based board, preferably for producing MDF or HDF boards.

In a preferred embodiment the recycled lignocellulose based boards are chosen from the list of: wood fiber boards, such as MDF boards or HDF boards and laminate comprising wood fiber board substrates. The recycled lignocellulose fragments are then recycled wood fibers. These wood fibers are then preferably used to make new MDF or HDF boards.

According to a first divergent variant, the present invention relates to a process for the production of recycled fibers, wherein the process comprises a first step in which refined material from recycled fiber-comprising elements is introduced into a receptacle, and wetted, heated and pressurized using steam; wherein the process comprises optionally a second step in which this material is kept under pressure and temperature for a certain amount of time in said receptacle,
wherein the process comprises a third step of steam explosion of the wetted, heated and pressurized material, in which the pressure in the receptacle is reduced by at least 3 bar, and preferably by at least 5 bar, more preferably by at least 7 bar; more preferably by at least 10 bar, more preferably by at least 11 bar; and in which recycled fibers, are produced during the steam explosion;
wherein the steam explosion is a multistage steam explosion, meaning that the reduction of the pressure takes place in at least two partial steps, wherein the multistage steam explosion comprises at least a first partial step wherein the pressure in the receptacle is reduced and a subsequent second partial step wherein the pressure in the receptacle is further reduced, wherein a first ratio of the pressure drop in the first partial step to the duration of the reduction of the pressure in the first partial step, is lower than a second ratio of the pressure drop in the second partial step to the duration of reduction of pressure in the second partial step.

According to a second divergent variant, the present invention relates to a process for the production of recycled fibers, wherein the process comprises a group of sequential steps, and the process makes use of at least a first receptacle and a second receptacle, wherein said group of sequential steps take place in the first receptacle and wherein said group of sequential steps also takes place in the second receptable, wherein said group of sequential steps at least comprises
a first step in which refined material from recycled fiber-comprising elements is introduced into the first receptacle or respectively the second receptacle, and is wetted, heated and pressurized using steam;
optionally a second step in which this material is kept under pressure and temperature for a certain amount of time in the first receptacle or respectively the second receptacle,
a third step of steam explosion of the wetted, heated and pressurized material, in which the pressure in the first receptacle or respectively the second receptacle is reduced by at least 3 bar, and preferably by at least 5 bar, more preferably by at least 7 bar; more preferably by at least 10 bar, more preferably by at least 11 bar; and in which recycled lignocellulose fragments are produced during the steam explosion;
   wherein
to reduce the pressure in the first receptacle or respectively the second receptacle in the third step, steam is released from the first receptacle or respectively the second receptacle and at least partially reused for pressurizing the second receptacle or respectively the first receptacle, and this at the time the first step takes place in the second receptacle or respectively the first receptacle, such that the steam is partially reused.

These fiber-comprising elements for the first and the second deviating variant may be, for example: insulation material, boards comprising plant fibers such as flax fiberboards, flax shive boards, hemp fiberboards, bamboo fiberboards. In this case, these fibers are, for example, flax fibers, hemp fibers, bamboo fibers. All the above-described embodiments for the process as described for the first aspect respectively for the second aspect according to the invention, apply mutatis mutandis for the first divergent variant respectively the second divergent variant.

With a view to providing a better illustration of the characteristic features of the invention, the following text describes a number of preferred embodiments by way of example, without any limiting character, with reference to the appended drawings, in which:

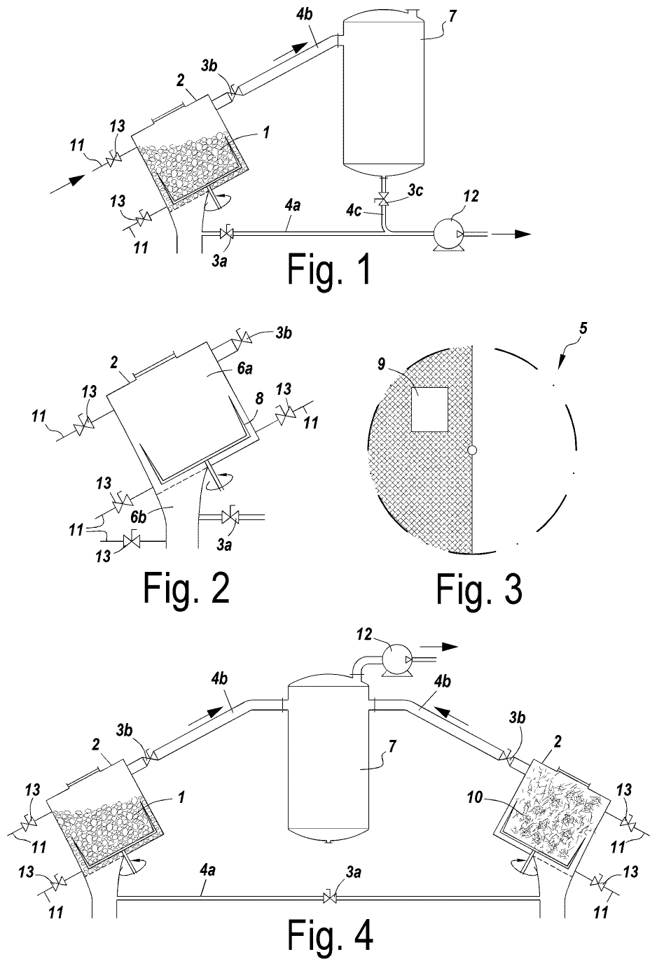

FIG. 1 illustrates part of an installation which can be used in a first embodiment of the process according to the invention for the production of a recycled wood fibers;

FIG. 2 shows a pressure vessel as can be used in embodiments of the invention, and positions of possible pipes and valves;

FIG. 3 illustrates a grid which can be installed in the pressure vessel;

FIG. 4 illustrates part of an installation which can be used in a second embodiment of the process according to the invention for the production of recycled wood fibers;

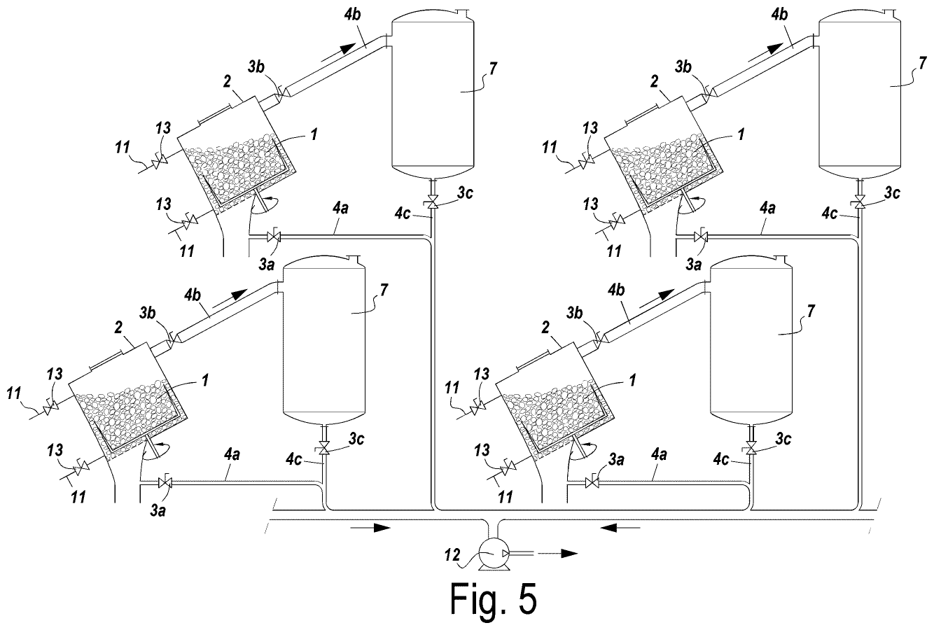

FIG. 5 illustrates part of an installation which can be used in a third embodiment of the process according to the invention for the production of a recycled wood fibers.

The installations are used for a process for the production of recycled wood fibers 10. Of course it can also be used to produce other lignocellulose fragments. The process comprises a first step in which refined material 1 from recycled MDF, HDF or laminate comprising HDF/MDF, is introduced into a receptacle, and wetted, heated and pressurized using steam; wherein the process comprises a second step in which this material is kept under pressure and temperature for a certain amount of time in said receptacle,
wherein the process comprises a third step of steam explosion of the wetted, heated and pressurized material, in which the pressure in the receptacle is reduced by at least 3 bar, and preferably by at least 5 bar, more preferably by at least 7 bar; more preferably by at least 10 bar, more preferably by at least 11 bar; and in which recycled wood fibers 10 are produced during the steam explosion. Further said steam explosion is a multistage steam explosion with two partial steps, meaning that the reduction of the pressure takes place in two partial steps.

FIG. 1 illustrates part of an installation that can be used in a first embodiment of the process according to the invention for the production of a recycled wood fibers 10. Here the process makes use of at least one receptacle, wherein this receptacle comprises a pressure vessel 2, pipes 4a, 4b, 11 connected to said pressure vessel 2, and valves 3a, 3b, 13 which ensure that said pipes 4a, 4b, 11 can be closed and opened as desired. Inside said pressure vessel 2 a grid 5 is present which divides said pressure vessel 2 in a higher area 6a above the grid 5 in which the refined material 1 is introduced and a lower area 6b below the grid 5. The receptacle further comprises a stirring mechanism 8 comprising agitators which are located and operably inside said higher area 6a. The receptacle comprises two steam inlet pipes 11 which are provided to inject steam inside said pressure vessel 2 and which can be closed with the aid of valves 13. The highest located steam inlet pipe 11 is able to fill up the pressure vessel 2 quickly with steam since the steam is injected inside said pressure vessel 2 in the higher area 6a at a location where normally no refined material 1 is present. The lowest located steam inlet 11 is provided to inject steam at the height of the grid 5 and this above the grid 5, thus in the higher area 6a. By injecting steam with said lowest located steam inlet 11, not only the pressure vessel 2 can get pressurized, but also the grid 5 can get cleaned. Cleaning can take place in said first step, but also before said first step such that the pressure vessel 2 is cleaned before introducing refined material 1 into said higher area 6a. The receptacle comprises a first pipe 4a which connects the lower area 6b of the pressure vessel 2 to a pump 12. A first valve 3a is provided to close and open the first pipe 4a. The receptacle comprises a second pipe 4b which connects the higher area 6a of the pressure vessel 2 to an expansion vessel 7, and this at a height above the refined material 1. Further said expansion vessel 7 connects trough a third pipe 4c to the first pipe 4a, such that it is also connected to the pump 12. Said third pipe 4c is closable by a valve 3c. In the first step, the refined material 1 is introduced in said higher area 6a and this while all the valves 3a, 3b, 3c, 13 are closed. For example, the introduction of said refined material 1 may take between 10 and 20 seconds. Then the valves 13 of the steam inlet pipes 11 are opened to inject steam in the pressure vessel 2 and to pressurize the pressure vessel 2 to a pressure of at least 11 bar. After this, the valves 13 of the steam inlet pipes 11 are closed. The injection of steam may take between 40 and 60 seconds. In the second step said pressure vessel 2 is kept under pressure and temperature for example between 5 and 15 seconds. Then in a third step multistage steam explosion with two partial steps takes places. During this steam explosion, recycled wood fibers 10 are formed. Firstly, in a first partial step of the third step, the valve 3a of the first pipe 4a is opened and the pressure is slowly released to a pressure of between 5 and 9 bar. During this first partial step, water can be discharged trough said first pipe 4a. Then, in a second partial step, the valve 3b of the second pipe 4b is opened and the pump 12 sucks air through the expansion vessel 7, such that the pressure drop is faster than in the first partial step. Before or during the second partial step, the valve 3a of the first pipe 4a can close. In the first partial step of the third step, the total pressure drop can be between 2 and 7 bar and it can take between 20 and 40 seconds. The second partial step of the third step can have a total pressure drop of at least 5 bar and preferably of between 6 and 10 bar, wherein the second partial step may take between 5 and 15 seconds. Preferably a first ratio of the total pressure drop to the total time in the first partial step is lower than a second ratio of the total pressure drop to the total time in the second partial step. By having a slower release of pressure in the first partial step, it is ensured that the steam explosion is not too powerful, such that the quality of the recycled wood fibers 10 is ensured.

FIG. 2 shows a pressure vessel 2 and more possibilities for the steam inlet pipes 11. With the aid of more steam inlet pipes 11, it can be ensured that the pressure vessel 2 does not get polluted with refined material 1 and/or recycled wood fibers 10 during use of said pressure vessel 2.

FIG. 3 shows a possible embodiment of the grid 5 located inside the pressure vessel 2 of FIG. 1. This grid 5 can have a grid structure over its total surface, but can also only have a grid structure at certain locations (see FIG. 3, wherein only one half of the circular shaped surface has a grid structure). This grid 5 also comprises a closable opening 9, such that the recycled wood fibers 10 can be released after the steam explosion.

FIG. 4 illustrates part of an installation that can be used in a second embodiment of the process according to the invention for the production of a wood fiberboard. Here the process makes use of at least two receptacles, wherein these receptacles each comprise a pressure vessel 2, pipes 4a, 4b, 11 connected to said pressure vessel 2, and valves 3a, 3b, 13 which ensure that said pipes 4a, 4b, 11 can be closed and opened as desired. What is special about this installation, is that the pressure vessels 2 are connected to each other with a first pipe 4a (see further). Inside each pressure vessel 2 a grid 5 is present which divides said pressure vessel 2 in a higher area 6a above the grid 5 in which the refined material 1 is introduced and a lower area 6b below the grid 5. Each receptacle further comprises a stirring mechanism 8 comprising agitators which are located and operably inside said higher area 6a. Each receptacle comprises two steam inlet pipes 11 which are provided to inject steam inside said pressure vessel 2 and which are closable with the aid of valves 13. The highest located steam inlet pipe 11 is able to fill up the pressure vessel 2 quickly with steam since the steam is injected inside said pressure vessel 2 in the higher area 6a at a location where normally no refined material 1 is present. The lowest located steam inlet 11 is provided to inject steam at the height of the grid 5 and this above the grid 5, thus in the higher area 6a. By injecting steam with said lowest located steam inlet 11, not only the pressure vessel 2 can get pressurized, but also the grid 5 can get cleaned. Cleaning can take place in said first step, but also before said first step such that the pressure vessel 2 is cleaned before introducing refined material 1 into said higher area 6a. Said first pipe 4a connects the lower areas 6b of said two pressure vessels 2 to each other. A first valve 3a is provided to close and open the first pipe 4a. Each receptacle further comprises a second pipe 4b which connects the higher area 6a of each pressure vessel 2 to an expansion vessel 7, and this at a height above the refined material 1. Further said expansion vessel 7 connects trough a third pipe 4c to a pump 12. In the first step, refined material 1 is introduced in said higher area 6a of one of said pressure vessels 2 and this while all the valves 3a, 3b, 13 are closed. For example this may take between 10 and 20 seconds. Then the valve 3a of the first pipe 4a and the valves 13 of the steam inlet pipes 11 of said pressure vessel 2 are opened to inject steam in the pressure vessel 2 and to pressurize said pressure vessel 2 to a pressure of at least 11 bar. Opening the valve 3a of the first pipe 4a aids in pressurizing said pressure vessel 2 and this because in the other pressure vessel 2 the first partial step of the steam explosion takes place (see further). In the second step said pressure vessel 2 is kept under pressure and temperature for example between 5 and 15 seconds. Then in the third step multistage steam explosion with two partial steps takes places. During this steam explosion, recycled wood fibers 10 are formed. Firstly, in the first partial step of the third step, the valve 3a of the first pipe 4a is opened and the pressure is slowly released to a pressure of between 5 and 9 bar. By opening said valve 3 a of the first pipe 4 a, the other pressure vessel 2 can get pressured, and part of the steam is reused. During this first partial step, water can be discharged from said first pipe 4a. Then, for the second partial step, the valve 3a of the first pipe 4a is closed and the valve 3b of the second pipe 4b is opened and the pump 12 sucks air through the expansion vessel 7, such that the pressure drop is faster than in the first partial step. In the first partial step of the third step, the total pressure drop can be between 2 and 7 bar and it can take between 20 and 40 seconds. The second partial step of the third step can have a total pressure drop of at least 5 bar and preferably of between 6 and 10 bar, wherein the second partial step may take between 5 and 15 seconds. Preferably a first ratio of the total pressure drop to the total time in the first partial step is lower than a second ratio of the total pressure drop to the total time in the second partial step. By having a slower release of pressure in the first partial step, it is ensured that the steam explosion is not too powerful, such that the quality of the recycled wood fibers 10 is ensured.

FIG. 5 illustrates part of an installation which can be used in a third embodiment of the process according to the invention for the production of a recycled wood fibers 10. Here the process makes use of four receptacles and four expansion vessels 7 as described in the first embodiment. Here alle the receptacles and expansion vessels 7 are connected to one pump 12.

The production of the recycled wood fibers 10 as illustrated in the figures are batch process. Preferably these batch processes are carried out in-line with the continuous production of new wood fiberboard.

1.-22. (canceled)

23. A process for the production of recycled wood fibers, wherein the process comprises a first step in which refined material from recycled lignocellulose based boards or panels is introduced into a receptacle, and wetted, heated and pressurized using steam;
wherein the process comprises a second step in which this material is kept under pressure and temperature for a certain amount of time in said receptacle,
wherein the process comprises a third step of steam explosion of the wetted, heated and pressurized material, in which the pressure in the receptacle is reduced by at least 3 bar; and in which recycled wood fibers are produced during said steam explosion;
wherein the steam explosion is a multistage steam explosion, meaning that the reduction of the pressure takes place in at least two partial steps, wherein the multistage steam explosion comprises at least a first partial step,
wherein the pressure in the receptacle is reduced, and a subsequent second partial step
wherein the pressure in the receptacle is further reduced,
wherein a first ratio of the pressure drop in the first partial step to the duration of the reduction of the pressure in the first partial step, is lower than a second ratio of the pressure drop in the second partial step to the duration of reduction of pressure in the second partial step.

24. The process according to claim 23, wherein the first ratio is at most 0,4 bar/second.

25. The process according to claim 23, wherein in the first partial step, the pressure reduction is at most 8 bar and/or wherein the duration of reduction of pressure in the first partial step is at least 10 seconds.

26. The process according to claim 23, wherein, during the first partial step, the ratio of the pressure drop to the duration of the reduction of the pressure is or is not approximately constant,
wherein the maximum ratio of the pressure drop to the duration of the reduction of the pressure in the first partial step, is at most 1 bar/second.

27. The process according to claim 23, wherein the second ratio is at least 0,25 bar/second.

28. The process according to claim 23, wherein the pressure drop of the first partial step is at least 30 percent of the total pressure drop in the third step.

29. The process according to claim 23, wherein the receptacle comprises a pressure vessel and a first flap or valve to release pressure from the pressure vessel,
wherein in the first step said first flap or valve is at least partially opened to release pressure.

30. The process according to claim 29, wherein liquid water can be discharged through said first flap or valve.

31. The process according to claim 29, wherein the receptacle comprises a second flap or valve,
wherein in the second step said second flap or valve is at least partially opened to release pressure.

32. The process according to claim 31, wherein the pressure vessel is positioned in such a way that it has a bottom side and a top side,
wherein the first flap or valve is located closer to the bottom side and the second flap valve is located closer to the upper side.

33. The process according to claim 29, wherein the receptacle comprises a grid which is positioned inside the pressure vessel and divides the pressure vessel in at least two distinct areas which extend above each other, a higher area above the grid wherein the refined material from recycled wood based boards or panels is introduced, and a lower area below the grid,
wherein the first valve or flap connects to the pressure vessel at the height of the lower area.

34. The process according to claim 29, wherein between the pressure vessel and a said valve or flap, a filter is present.

35. The process according to claim 29, wherein a said valve or flap is connected to an expansion vessel.

36. A process, for the production of recycled wood fibers, wherein the process comprises a group of sequential steps, and the process makes use of at least a first receptacle and a second receptacle,
wherein said group of sequential step take place in the first receptacle and
wherein said group of sequential steps also takes place in the second receptable, wherein said group of sequential steps at least comprise
a first step in which refined material from recycled lignocellulose based boards or panels is introduced into the first receptacle or respectively the second receptacle, and is wetted, heated and pressurized using steam;
a second step in which this material is kept under pressure and temperature for a certain amount of time in the first receptacle or respectively the second receptacle,
a third step of steam explosion of the wetted, heated and pressurized material, in which the pressure in the first receptacle or respectively the second receptacle is reduced by at least 3 bar; and in which recycled wood fibers are produced during said steam explosion;
wherein to reduce the pressure in the first receptacle or respectively the second receptacle in the third step, steam is released from the first receptacle or respectively the second receptacle and at least partially reused for pressurizing the second receptacle or respectively the first receptacle, and this at the time the first step takes place in the second receptacle or respectively the first receptacle, such that the steam is partially reused.

37. The process according to claim 36, wherein the steam explosion is a multistage steam explosion, meaning that the reduction of the pressure takes place in at least two partial steps;
wherein the multistage steam explosion comprises at least a first partial step
wherein the pressure in the receptacle is reduced and a subsequent second partial step
wherein the pressure in the receptacle is further reduced,
wherein the partially reusing of the steam takes places in the first partial step.

38. The process according to claim 37, wherein in the first partial step, the pressure is released until the pressure in the first and the second receptacle differs at most 2 bar.

39. The process according to claim 36, wherein a flap or valve is arranged between the first and second receptacle as such to release the steam from one said receptacle and to reuse is in the other said receptacle.

40. The process according to claim 36, wherein each receptacle is further connected to an expansion vessel to further reduce the pressure.

41. A process for the production of recycled wood fibers, wherein the process comprises a first step in which refined material from recycled lignocellulose based boards or panels is introduced into a receptacle, and wetted, heated and pressurized using steam;
wherein the process comprises a second step in which this material is kept under pressure and temperature for a certain amount of time in said receptacle,
wherein the process comprises a third step of steam explosion of the wetted, heated and pressurized material, in which the pressure in the receptacle is reduced by at least 3 bar; and in which recycled wood fibers are produced during said steam explosion
wherein the receptacle comprises a pressure vessel in which refined material from recycled lignocellulose based boards or panels is introduced,
wherein the receptacle comprises a stirring mechanism,
wherein this stirring mechanism comprises one or more agitators located in said pressure vessel to mix the refined material in the receptacle at least for a portion of the time period of the first step and/or the second step.

42. The process according to claim 41, wherein the receptacle comprises a grid which is positioned inside the pressure vessel and divides the pressure vessel in at least two distinct areas which extend above each other, a higher area above the grid wherein the refined material from recycled wood based boards or panels is introduced and a lower area below the grid,
wherein the one or more agitators are located in said higher area, and
wherein further preferably the grid comprises a closable opening,
wherein said one or more agitators are also provided to stir after the steam explosion of the third step such as to guide the recycled wood fibers trough said opening and out of said pressure vessel.
